(19) United States
(12) Patent Application Publication
(10) Pub. No.: US 2013/0074347 A1
(43) Pub. Date: Mar. 28, 2013

(54) RECHARGEABLE PLATE JOINER

(71) Applicants: Kenji ABE, Anjo-shi (JP); Sho KUME, Anjo-shi (JP)

(72) Inventors: Kenji ABE, Anjo-shi (JP); Sho KUME, Anjo-shi (JP)

(73) Assignee: MAKITA CORPORATION, Anjo-shi (JP)

(21) Appl. No.: 13/593,052

(22) Filed: Aug. 23, 2012

(30) Foreign Application Priority Data
Sep. 22, 2011 (JP) 2011-207817

(51) Int. Cl. B26B 25/00

(52) U.S. Cl. 30/273

(57) ABSTRACT

An attachment portion of a battery pack serving as a power supply is formed on a rear end of a motor housing of a rechargeable plate joiner, and the battery pack is slid and attached to the attachment portion of the horizontally disposed motor housing from above. In this state, a center of gravity position of the battery pack is positioned on an axis line of an output shaft of a motor.

### BACKGROUND OF THE INVENTION

This application claims the benefit of Japanese Patent Application Number 2011-207817 filed on Sep. 22, 2011, the entirety of which is incorporated by reference.

### TECHNICAL FIELD

The present invention relates to a rechargeable plate joiner for forming a groove in a joint surface of a machined workpiece during miter joint formation and coupling formation.

### BACKGROUND ART

In a rechargeable plate joiner (to be referred to simply as a “plate joiner” hereafter), a front housing that rotatably supports a spindle in a downward orientation is connected to a front of a tubular motor housing that houses a motor in a forward orientation. A base that houses a disc-shaped cutter attached to a lower end of the spindle and has an opening in a front end thereof is provided in a lower portion of the front housing. The base can move in a front-rear direction and is biased in a normal state to an advancement position in which the cutter does not project through the opening. In other words, the plate joiner is advanced while a front end surface of the base contacts a machining surface of a machined workpiece, and a groove is formed in the machining surface by the cutter projecting through the opening. Further, a fence that contacts the machined workpiece in alignment with an angle of the machining surface is provided on the front end of the base (see Japanese Utility Model Application Publication No. H5-35209).

This type of plate joiner primarily employs an AC motor that uses a commercial power supply as a power supply. However, operability may be impaired when a power cord causes an obstruction or the like. Therefore, a plate joiner such as that described in Japanese Patent Application Publication No. 2001-79784, in which a DC motor is installed and a battery pack serving as a power supply is attached to a rear end of the motor housing so that the operability is improved, has been developed.

### SUMMARY OF THE INVENTION

In the plate joiner of Japanese Patent Application Publication No. 2001-79784, however, the battery pack is attached to the motor housing by being inserted from the rear, and therefore the battery pack cannot be inserted and removed easily when the plate joiner is placed on a workbench or the like. To find an insertion position, the plate joiner must be lifted up and set in an upright attitude with the base oriented downward.

An object of the present invention is therefore to provide a user-friendly plate joiner in which battery pack attachment and detachment operations can be performed easily while maintaining the favorable operability obtained through use of the battery pack.

To achieve this object, according to a first aspect of the present invention, a rechargeable plate joiner includes

a tubular motor housing in which a motor is housed in a forward orientation,

a front housing that is connected to a front of the motor housing and rotatably supports a downwardly oriented spindle to which rotation is transmitted from an output shaft of the motor,

a battery pack attached detachably to an attachment portion provided on a rear of the motor housing,

a disc-shaped cutter attached to a lower end of the spindle, and

a base that is provided in a lower portion of the front housing, houses the cutter, and has an opening in a front end thereof, the base being capable of moving in a front-rear direction, being biased to an advancement position in which the cutter does not project through the opening in a normal state, and enabling groove forming by advance of the front housing when in contact with a machined workpiece such that the cutter projects through the opening. In the rechargeable plate joiner, the battery pack is slid and attached to the attachment portion.

According to a second aspect of the present invention, in the configuration according to the first aspect, the battery pack is slid and attached at a predetermined angle relative to the front-rear direction.

According to a third aspect of the present invention, in the configuration according to the second aspect, the predetermined angle is set at 90°.

According to a fourth aspect of the present invention, in the configuration according to the first aspect, a center of gravity position of the battery pack is set on an axis line of the output shaft of the motor.

According to a fifth aspect of the present invention, in the configuration according to the first aspect, a distance from the center of gravity position of the battery pack to a center of a thickness of the cutter in an axis line direction of the spindle is set between 40 mm and 70 mm.

According to the first aspect, operations to attach and detach the battery pack can be performed easily even when the plate joiner is disposed horizontally, and at the same time, the favorable operability obtained through use of the battery pack can be maintained. As a result, the user-friendliness of the plate joiner is improved.

According to the second and third aspects, in addition to the effects of the first aspect, the motor housing can be gripped forcefully by one hand during attachment and detachment of the battery pack, making the attachment and detachment operations easy.

According to the fourth aspect, in addition to the effects of the first aspect, favorable balance can be achieved in the front-rear direction by setting the center of gravity position of the battery pack. Therefore an attitude of the plate joiner can be maintained with stability even during an operation in which the plate joiner is oriented vertically with the battery pack on an upper side.

According to the fifth aspect, in addition to the effects of the first aspect, by setting the dimension between the center of gravity position of the battery pack and the cutter, an increase in compactness can be achieved as well as favorable balance.

### BRIEF DESCRIPTION OF THE DRAWINGS

FIG. 1 is a longitudinal sectional view of a plate joiner.

FIG. 2 is a side view of the plate joiner.

FIG. 3 is a front view of the plate joiner.

FIG. 4 is a plan view of the plate joiner.

### DETAILED DESCRIPTION OF THE EMBODIMENTS

An embodiment of the present invention will be described below on the basis of the drawings.

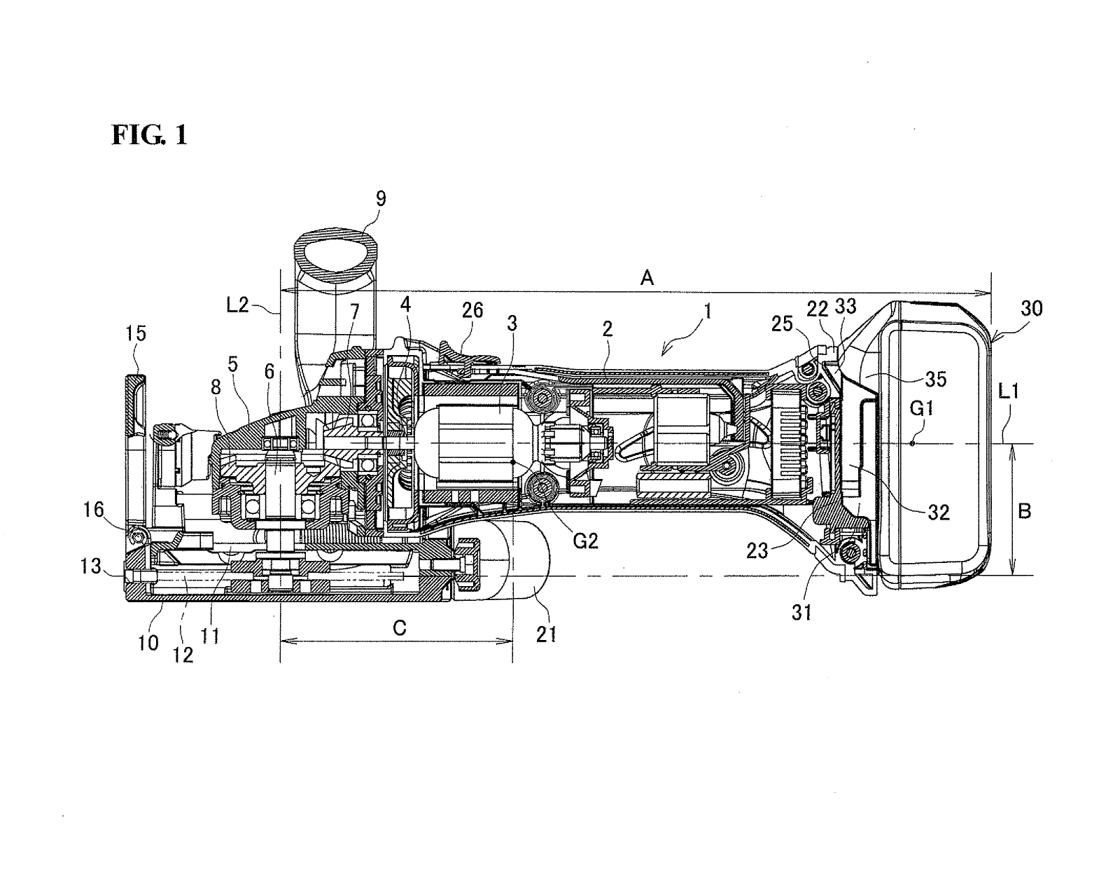

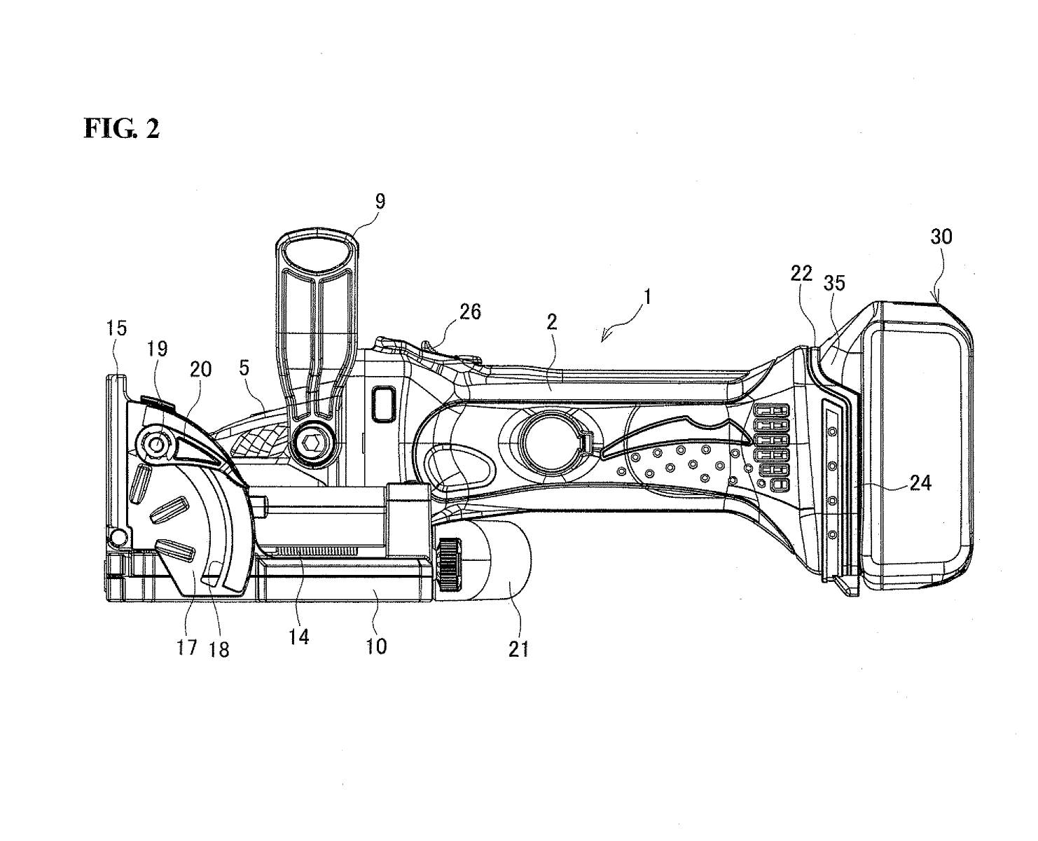

FIG. 1 is a longitudinal sectional view showing an example of a plate joiner, and FIG. 2 is a side view thereof. In a plate joiner 1, a gear housing 5 serving as a front housing that rotatably supports a spindle 6 in a downward orientation is connected to a front of a tubular motor housing 2 that houses a motor (a DC motor) 3 in a forward orientation (in FIGS. 1 and 2, a left side corresponds to the front). A bevel gear 7 is provided on an output shaft 4 of the motor 3, and by meshing the bevel gear 7 to a bevel gear 8 fixed to the spindle 6, rotation of the output shaft 4 can be transmitted to the spindle 6. Reference numeral 9 denotes a grip that extends in a left-right direction above the gear housing 5 such that respective ends thereof are connected to left and right side faces of the gear housing 5.

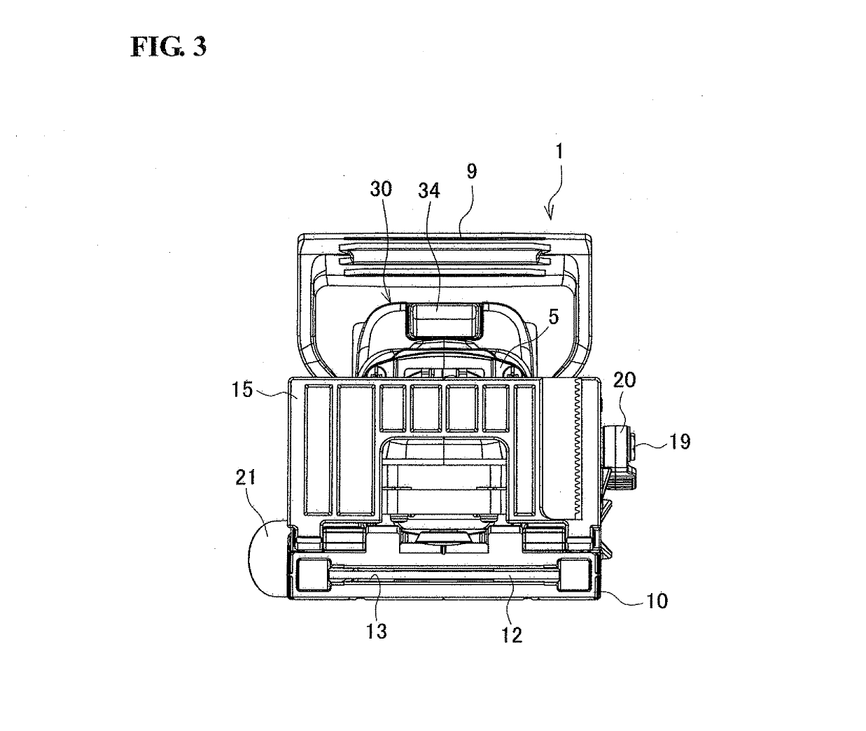

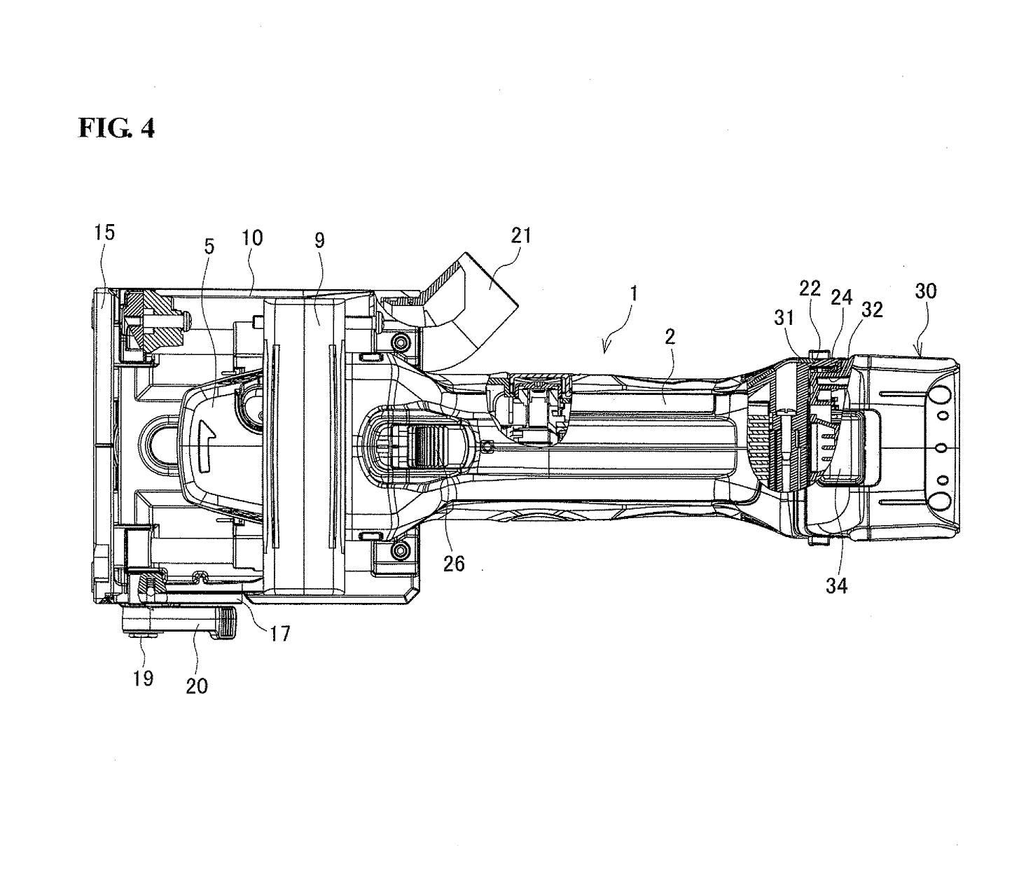

As shown in FIGS. 3 and 4, a box-shaped base 10 that is rectangular when seen from above and has a hollow interior is connected to a lower surface of the gear housing 5 so as to be capable of sliding in a front-rear direction. The spindle 6 passes through an elongated hole 11 that is provided to extend in the front-rear direction in an upper surface of the base 10 so as to project into the base 10, and a disc-shaped cutter 12 is attached orthogonally to a lower end of the spindle 6. An opening 13 through which the cutter 12 projects forward when the base 10 retreats relative to the gear housing 5 is formed in a front surface of the base 10. The base 10 is biased to an advancement position, in which the entire cutter 12 is fitted in the base 10, by a coil spring 14 provided between the base 10 and the gear housing 5.

Further, a fence 15 is rotatably attached to a front end upper portion of the base 10 by a spindle 16 so as to be capable of rotating between a vertical position orthogonal to the base 10 and a horizontal position parallel with the base 10, in which the fence 15 projects forward. A fan-shaped guide plate 17 extends rearward from a side edge of the base 10. A bolt 19 penetrating an arc-shaped guide hole 18 drilled into the guide plate 17 is screwed to the base 10 side. By performing a rotation operation of the bolt 19 using a lever 20, the fence 15 can be fixed at a desired angle within a 90° range. It should be noted that an angle guide, not shown in the drawings, that projects orthogonally forward from a front surface of the fence 15 can be attached to and detached from the fence 15. Reference numeral 21 denotes a nozzle that is connected to a rear surface of the base 10 to discharge chips from the interior of the base 10.

An attachment portion 22 of a battery pack 30 serving as a power supply is formed on a rear end of the motor housing 2. A terminal block 23 having a vertical direction terminal strip (not shown) that projects from a rear surface thereof is provided in the attachment portion 22. Further, holding portions 24 having ridges, not shown in the drawings, provided to project from respective rear end inner sides thereof are formed respectively on left and right sides of the attachment portion 22. A recessed portion 25 is formed in a rear surface of the attachment portion 22 on an upper side of the holding portions 24. Meanwhile, a plurality of storage batteries (lithium ion batteries, for example) are housed in the battery pack 30, and a joint portion 31 that is joined to the attachment portion 22 is provided to project from a left side of the battery pack 30 in FIG. 1. A connection terminal, not shown in the drawings, is provided in the interior of the joint portion 31, and rail portions 32, with which the ridges of the respective holding portions 24 are engaged, are formed on respective sides of the joint portion 31. Further, a hook 33 is provided on top of the joint portion 31. The hook 33 is biased to project from the joint portion 31 to a projecting position, and can be fitted in the joint portion 31 through an operation of a button 34 provided on an upper surface of the joint portion 31. Stopper portions 35 are provided on either side of the hook 33 to contact respective upper ends of the holding portions 24.

Hence, when the battery pack 30 is slid downward between the holding portions 24 in alignment with the joint portion 31 while the plate joiner 1 is set in a horizontal orientation, as shown in FIGS. 1 and 2, the rail portions 32 slide downward along the ridges of the holding portions 24 and the terminal strip of the terminal block 23 advances into the joint portion 31. When the stopper portions 35 contact the respective upper ends of the holding portions 24, the hook 33, after initially contacting the upper end of the attachment portion 22 so as to be temporarily fitted in the joint portion 31, projects in the position of the recessed portion 25 so as to be latched to the recessed portion 25. In this state, an electric connection is established between the terminal strip and the connection terminal. It should be noted that the battery pack 30 can be detached upward by sliding of the button 34 rearward to release the latch between the hook 33 and the recessed portion 25.

In this attached state, a center of gravity position G1 of the battery pack 30 is positioned on an axis line L1 of the motor 3. Further, a front-rear direction (an axis line L1 direction) distance A from an axis line L2 of the spindle 6 passing through a center of the cutter 12 to a rear end surface of the battery pack 30 is set at 270 mm here and preferably set between 250 mm and 300 mm. Furthermore, a vertical direction distance B from a center of a thickness direction of the cutter 12 to the center of gravity position G1 of the battery pack 30 is set at 50 mm here and preferably set between 40 mm and 70 mm. By setting the dimensions as described above, favorable balance is realized when the motor housing 2, which also serves as a grip portion, is gripped. Therefore, improvement in operability is achieved during groove forming performed with the plate joiner 1 either horizontally oriented, as in FIGS. 1 and 2, or oriented upright. In particular, the axis line LI of the motor 3 is aligned with the center of gravity of a product not including the base 10 and the battery pack 30. Therefore, by aligning the axis line L1 with the center of gravity position G1 of the battery pack 30, the plate joiner 1 is unlikely to fall when placed upright with the fence 15 side down. As a result, favorable operability is achieved.

In addition, an overall center of gravity position G2 when the battery pack 30 is attached is set further toward the cutter 12 side (a lower side in FIG. 1) than the axis line L1 of the motor 3. Furthermore, a front-rear direction distance C from the axis line L2 of the spindle 6 to the center of gravity position G2 is set at 40 mm here and preferably set between 0 and 90 mm. With this setting, the plate joiner 1 is less likely to tilt to the battery pack 30 side during groove forming in which the fence 15 is brought into contact with a machined workpiece while the plate joiner 1 is oriented horizontally (including an inclined attitude). As a result, the operation can be performed with stability.

To perform groove forming using the plate joiner 1 configured as described above, the motor housing 2 is gripped with one hand, the grip 9 is gripped with the other hand, and the front end of the base 10 is brought into contact with a machining surface of the machined workpiece. When, in this state, the motor 3 is driven by operating a switch lever 26 provided on an upper surface of the motor housing 2, the cutter 12 rotates together with the spindle 6. When the plate joiner 1 is pushed forward in this case, the cutter 12 projects through the opening 13 while the position of the base 10 remains unchanged, and as a result, a groove is formed in the machining surface.

Here, the respective distances A to C and the center of gravity positions G1, G2 are set relative to the attached battery pack 30 as described above, and therefore the operation can be performed easily and with stability.

It should be noted that by setting a rotation speed of the motor 3 between 5000 min⁻¹ and 10000 min⁻¹ (preferably 8000 min ⁻¹) in the plate joiner 1, which has a mass of no more than 3.5 kg and a maximum output of no more than 500 W when the battery pack 30 of no more than 24 V is attached, sufficient power is obtained regardless of the type and grain direction of the wood constituting the machined workpiece, and therefore a favorable finish without fuzz is obtained.

Hence, with the plate joiner 1 according to this embodiment, the battery pack 30 is slid and attached to the attachment portion 22, and therefore operations to attach and detach the battery pack 30 can be performed easily even when the plate joiner 1 is disposed horizontally. At the same time, the favorable operability obtained through use of the battery pack 30 can be maintained. As a result, the user-friendliness of the plate joiner 1 is improved.

Here in particular, the battery pack 30 is slid and attached at a predetermined angle (90° here) relative to the front-rear direction, and therefore the motor housing 2 can be gripped forcefully by one hand during attachment and detachment of the battery pack 30, making the attachment and detachment operations easy.

Further, by setting the center of gravity position G1 of the battery pack 30 on the axis line L1 of the output shaft 4 of the motor 3, favorable balance can be achieved in the front-rear direction. Therefore, the attitude of the plate joiner 1 can be maintained with stability even during an operation in which the plate joiner 1 is oriented vertically with the battery pack 30 on the upper side.

Moreover, the distance from the center of gravity position of the battery pack 30 to the center of the thickness of the cutter 12 in an axis line direction of the spindle 6 is set between 40 mm and 70 mm, and therefore an increase in compactness can be achieved as well as favorable balance.

It should be noted that the slide for attachment is not limited to downward sliding, and may be left-right direction sliding or diagonal direction sliding. Further, the angle of the attachment relative to the axis line of the motor housing is set at 90° in the above embodiment, but is not limited thereto and may be an acute angle of less than 90°. Moreover, the respective center of gravity positions and distances are not limited to the positions and numerical values of the above embodiment as long as the battery pack can be slid and attached in a manner enabling stable operations.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

What is claimed is:

1. A rechargeable plate joiner comprising:
a tubular motor housing in which a motor is housed in a forward orientation;
a front housing that is connected to a front of the motor housing and rotatably supports a downwardly oriented spindle to which rotation is transmitted from an output shaft of the motor;
a battery pack attached detachably to an attachment portion provided on a rear of the motor housing;
a disc-shaped cutter attached to a lower end of the spindle; and
a base that is provided in a lower portion of the front housing, houses the cutter, and has an opening in a front end thereof, the base being capable of moving in a front-rear direction, being biased to an advancement position in which the cutter does not project through the opening in a normal state, and enabling groove forming by advance of the front housing when in contact with a machined workpiece such that the cutter projects through the opening, wherein
the battery pack is slid and attached to the attachment portion.

2. The rechargeable plate joiner according to claim 1, wherein the battery pack is slid and attached at a predetermined angle relative to the front-rear direction.

3. The rechargeable plate joiner according to claim 2, wherein the predetermined angle is set at 90°.

4. The rechargeable plate joiner according to claim 1, wherein a center of gravity position of the battery pack is set on an axis line of the output shaft of the motor.

5. The rechargeable plate joiner according to claim 1, wherein a distance from the center of gravity position of the battery pack to a center of a thickness of the cutter in an axis line direction of the spindle is set between 40 mm and 70 mm.

6. The rechargeable plate joiner according to claim 5, wherein the distance is set at 50 mm.

7. The rechargeable plate joiner according to claim 1, wherein a front-rear direction distance from an axis line of the spindle passing through a center of the cutter to a rear end surface of the battery pack is set between 250 mm and 300 mm.

8. The rechargeable plate joiner according to claim 7, wherein the distance is set at 270 mm.

9. The rechargeable plate joiner according to claim 1, wherein an overall center of gravity position when the battery pack is attached is set to be further toward the cutter side than an axis line of the motor.

10. The rechargeable plate joiner according to claim 1, wherein a front-rear direction distance from an axis line of the spindle to an overall center of gravity position when the battery pack is attached is set between 0 and 90 mm.

11. The rechargeable plate joiner according to claim 10, wherein the distance is set at 40 mm.

12. The rechargeable plate joiner according to claim 1, wherein a fence is attached to a front end upper portion of the base through a shaft, the fence being configured to rotate between a vertical position orthogonal to the base and a horizontal position parallel with the base, in which the fence projects forward.

13. The rechargeable plate joiner according to claim 1, wherein holding portions are formed respectively on left and right sides of the attachment portion, a joint portion including rail portions is formed on the battery pack, and the battery pack is attached by sliding the joint portion between the holding portions such that the rail portions engage with the holding portions.
